(19) United States
(12) Patent Application Publication
(10) Pub. No.: US 2004/0165051 A1
(43) Pub. Date: Aug. 26, 2004

(54) Apparatus and method for recycling toner in a printed image display system

(76) Inventors: Serge Steinblatt, Ra'anana (IL); Yosef Kamir, Netanya (IL); Uri Adler, Holon (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/745,596

(22) Filed: Dec. 29, 2003

Related U.S. Application Data
(60) Provisional application No. 60/439,806, filed on Jan. 14, 2003.

(51) Int. Cl. B41J 2/385

(52) U.S. Cl. 347/115

(57) ABSTRACT

A system, apparatus, and method for toner recycling in a printed image display system. The display system, in conjunction with the printing apparatus, according to some embodiments of the present invention, may enable printing a color image using a plurality of toner colors, erasing the image from the substrate, collecting the erased mixture of toner colors, separating the toner colors, and recycling the toner colors for use in further printing.

### CROSS REFERENCE TO RELATED APPLICATIONS

This application claims the benefit of U.S. Patent Application 60/439,806, filed 14 Jan. 2003, entitled “AN APPARATUS AND METHOD FOR ERASING A SCREEN BASED PRINTED IMAGE”, which is incorporated in its entirety herein by reference.

### FIELD OF THE INVENTION

The present invention relates to display boards in general and to a system and method for efficiently erasing and reprinting displayed information on the display boards in particular.

### BACKGROUND OF THE INVENTION

One common form of displaying media uses poster displays located at strategic locations for maximum exposure. Various methods and systems are used to print content on such poster displays. Further, methods and systems are known for enabling remote printing or writing on such poster displays, as described in U.S. application Ser. No. 09/781,900, publication no. 20020109663 A1, and PCT application WO 02/065433 A2, both by a common inventor, which are incorporated by reference in their entirety.

It would be highly advantageous to have a system and/or method to improve printing efficiency for content printing on such display boards and other display media, to increase the yield of printing materials used during such printing.

### SUMMARY OF THE INVENTION

The present invention provides a display system and printing apparatus that enable toner recycling in a printed image display system. The display system, in conjunction with the printing apparatus, according to some embodiments of the present invention, may enable writing (hereinafter referred to as “printing”) a color image on a substrate using a plurality of toner colors, erasing the image from the substrate, collecting the erased mixture of toner colors, separating the toner colors, and returning each of the separated color toners in their corresponding color toner cassettes, to be recycled and used in printing at least one other color image.

Moreover, in accordance with an embodiment of the present invention, a plurality of toner colors may be printed onto and extracted from a plurality of substrates. The toner colors extracted from each substrate may be deleted, collected, and separated, either independently for each substrate, or together with the toner deleted from the other substrates.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic illustration of a prior art display system;

FIG. 2 is a schematic illustration of a display system and printing apparatus, according to an embodiment of the present invention; and

FIG. 3 is an illustration of a method of implementing an embodiment of the present invention.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

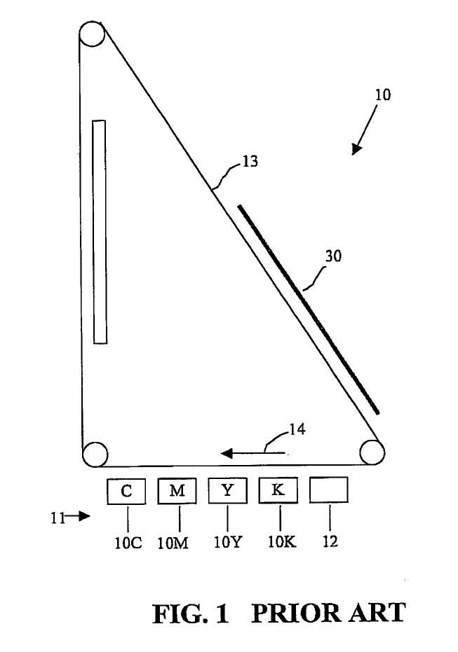

Reference is now made to FIG. 1 which is a schematic block diagram illustration of a display system described in US application, publication no. 20020109663 A1 and PCT application WO 02/065433 A2, both by a common inventor, which are incorporated by reference in their entirety. As can be seen in FIG. 1, which is partially reproduced from WO 02/065433 A2, display system 10 is provided, which may include a printing apparatus 11. Printing apparatus 11 may include an erasing unit 12, which may enable erasing of an image, e.g., a previously printed image on a zone 30 of an imaging belt 13. Zone 30, on which an image may be printed, may be part of imaging belt 13, and may be moved by imaging belt 13. Imaging belt 13 may move substrate zone 30, for example, past printing apparatus 11, in the direction indicated by arrow 14, such that, for example, a printed image may be deleted by erasing unit 12, and a new image may be printed by printing apparatus 11. For example, the imaging and printing of a new color image may occur at the CMYK units 10C, 10M, 10Y and 10K respectively. In the current example, C stands cyan, M stands for magenta, Y stands for yellow, and K stands for black.

According to an embodiment of the present invention, a multi-color printable display system and a printing apparatus may be provided. Such a display system and printing apparatus may enable printing of multiple color images on billboards or alternative display panels, partially or completely by using recycled toner that may be recycled following deletion of previously printed colored images. The display system and/or printing apparatus may be connected to a communication network, to enable a transfer of instructions to the display system and/or printing apparatus, for example, to print a new image, erase a current image, and display the new image. Images may be printed by the printing apparatus using xerographic, ionographic, magnetographic or any alternative printing method, on a single substrate. These images may not be fused on the substrate on which they are printed, to enable removal of the printed images and their replacement by new images.

According to an embodiment of the present invention, the printing apparatus may erase the image at a selected time, using an erasing unit to erase the various toner colors from the substrate layer. The resulting mixture of toners may be collected in a receptacle. While the various toners, for example C, M, Y and K may be mixed in the receptacle, the individual toner colors may be unable to be re-used for printing purposes.

According to an embodiment of the present invention, multiple or recycled usage of toner elements may be enabled, by separating the collected toner elements after image deletion into a plurality of toner elements, according to the component, base, or original colors of the toner mixture. A toner separating unit may separate the mixture of erased colors into component colors, such as clean base toners, for example, Cyan, Magenta, Yellow and Black (C, M, Y and K) toners.

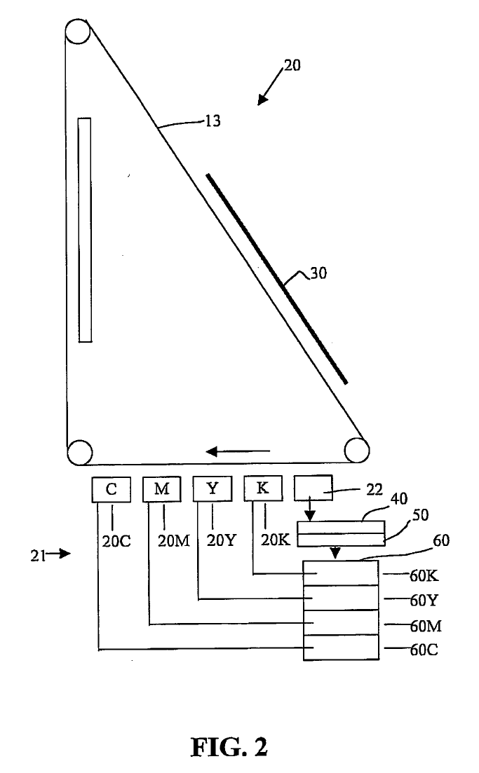

Reference is now made to FIG. 2, which illustrates a display system and printing apparatus, according to an embodiment of the present invention. As can be seen in FIG. 2, display system 20 may be functionally connected to a printing apparatus 21. Printing apparatus 21 may include a printing unit, which may include, for example, printing heads for printing an image using toners, such as C, M, Y, and K or any other base colors. Printing apparatus 21 may include toner separation unit 50, to separate the mixture of toner colors from a deleted image into component or base colors (for example, original toner colors). Printing apparatus 21 may include a transporting mechanism (not shown in figure), such as a pump, may also be provided, if necessary, to transport the toner colors from the erasing unit 22 to a receptacle 40 (optional) and/or to toner separation unit 50. The transporting mechanism may also enable transportation of the toner colors from the toner separation unit 50 to a second receptacle 60 (optional), where the separated toner elements may be stored. The transporting mechanism may also enable transportation of the toner colors from second receptacle 60 to the corresponding color toner cassettes (e.g., C, M, Y and K) within printing apparatus 21.

As can be further seen in FIG. 2, the toner mixture collected in first receptacle 40 may include toners of various colors. This toner mixture may be transferred to the toner separation unit 50, which may enable various possible toner separation mechanisms or methods, including but not limited to voltage-based separation, centrifugal separation, and chemical separation etc., which are known in the art. An example of such a mechanism is described in U.S. Pat. No. 5,815,785, titled “Method and apparatus for mixed color toners separation and recovery”, which is incorporated by reference in its entirety. After the separation of the mixed toner solution to its component, base, or original colors by toner separation unit 50, each of the toner colors may be transferred by a pumping mechanism, or any other toner transportation mechanism, to a second receptacle 60, which may hold the various colored toners in separate compartments, such as 60K, 60Y, 60M and 60C.

The separated toner colors may be transferred to the corresponding color toner cassettes within display system 20, for example, from 60C to 20C, from 60M to 20M, from 60Y to 20Y, and from 60K to 20K. In this way, the mixed toner solution may be recycled for multiple usages by printing apparatus 21. The first and second receptacle units may be containers for storing the toner content, and are optional components of the present invention.

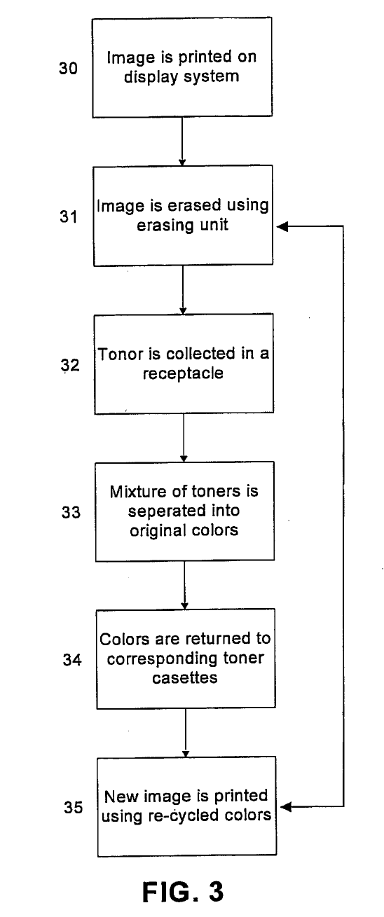

Reference is now made to FIG. 3, which describes an embodiment of a printing method, according to an embodiment of the present invention, wherein toner is recycled and used. At block 30, an image may be printed on a display system. At block 31 the image may be erased by an erasing mechanism. At block 32 the various toners (colors) extracted from the deleted image may be collected into a receptacle. The toner colors may be mixed together in the receptacle. At block 33 the mixture of toner colors may be separated into component or original colors, by a toner separation unit. At block 34 the various colors may be returned to their corresponding color toner cassettes within the printing mechanism of the display system. In block 35, the various toner colors, which have been recycled, may be used by the printing mechanism when printing new images. New images may likewise be erased, etc., at block 31.

According to a further embodiment of the present invention, display system 20 may print an image onto a plurality of substrates, each substrate optionally having a plurality of toner colors printed onto it. Upon erasing of such an image, the various colors that comprise the image on each substrate may be deleted, collected, and separated into the component colors, either independently for each substrate, or together with the toner elements deleted from the other substrates.

Any combination of the above steps may be implemented. Further, other steps or series of steps may be used.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. An apparatus for recycling toner from a screen based printed image, comprising:
a deletion unit; and
a toner separation unit.

2. The apparatus of claim 1, comprising at least one receptacle, said receptacle for storing respective toner elements separated by said toner separation unit.

3. The apparatus of claim 1, comprising a transportation mechanism to transport separated toner elements to a plurality of toner cartridges.

4. A printing system, comprising:
a printing apparatus including a deletion unit; and
a toner separation unit to separate mixed toner elements in said deletion unit.

5. The system of claim 4, comprising at least one receptacle to store respective separated toner elements.

6. A method for recycling toner in a print-based display system, comprising:
collecting a plurality of toner colors from toner erased from an image; and
separating said plurality of toner colors into component toner colors.

7. The method of claim 6, comprising transporting each of said component toner colors to respective toner cassettes.

8. The method of claim 6, comprising printing at least one image using said separated toner colors.
